(19) United States
(12) Patent Application Publication
(10) Pub. No.: US 2013/0322415 A1
(43) Pub. Date: Dec. 5, 2013

(54) LOCATION TRACKING FOR MOBILE TERMINALS AND RELATED COMPONENTS, SYSTEMS, AND METHODS

(71) Applicants: Aravind Chamarti, Falls Church, VA (US); Rajeshkannan Palanisamy, Painted Post, NY (US); Michael Sauer, Corning, NY (US)

(72) Inventors: Aravind Chamarti, Falls Church, VA (US); Rajeshkannan Palanisamy, Painted Post, NY (US); Michael Sauer, Corning, NY (US)

(21) Appl. No.: 13/485,038

(22) Filed: May 31, 2012

(51) Int. Cl. H04W 84/12

(52) U.S. Cl. 370/338

(57) ABSTRACT

A location tracking for mobile terminals is disclosed. Related components, systems, and methods are also disclosed herein. For example, the systems disclosed herein can provide location information to mobile terminals that may not be able to receive otherwise global positioning system (GPS) information from the GPS satellites, such as, for example, when the mobile terminal is not within line of sight of the GSP satellites. The location information may be provided through a service set identifier (SSID) signal. Providing location information may make location based services, such as emergency (E911) services, for example, possible based on the location information.

### BACKGROUND

1. Field of the Disclosure

The technology of the disclosure relates to location based systems used for tracking locations of mobile terminals, including distributed antenna systems.

2. Technical Background

Wireless communication is rapidly growing, with ever-increasing demands for high-speed mobile data communication. As an example, so-called “wireless fidelity” or “WiFi” systems and wireless local area networks (WLANs) are being deployed in many different types of areas (e.g., coffee shops, airports, libraries, etc.). Distributed communications or antenna systems communicate with wireless devices called “clients,” “client devices,” or “wireless client devices,” which must reside within the wireless range or “cell coverage area” in order to communicate with an access point device. Distributed antenna systems are particularly useful to be deployed inside buildings or other indoor environments where client devices may not otherwise be able to effectively receive RF signals from a source, such as a base station for example.

One approach to deploying a distributed communications system involves the use of radio frequency (RF) antenna coverage areas, also referred to as “antenna coverage areas.” Antenna coverage areas can have a relatively short range. Combining a number of access point devices creates an array of antenna coverage areas. Because the antenna coverage areas each cover small areas, there are typically only a few users (clients) per antenna coverage area. This allows for minimizing the amount of bandwidth shared among the wireless system users. It may be desirable to provide antenna coverage areas in a building or other facility to provide distributed communications system access to clients within the building or facility. However, it may be desirable to employ optical fiber to distribute communication signals. Benefits of optical fiber include increased bandwidth.

One type of distributed communications system for creating antenna coverage areas, called “Radio-over-Fiber” or “RoF,” utilizes RF signals sent over optical fibers. Such systems can include a head-end station optically coupled to a plurality of remote antenna units that each provides antenna coverage areas. The remote antenna units can each include RF transceivers coupled to an antenna to transmit RF signals wirelessly, wherein the remote antenna units are coupled to the head-end station via optical fiber links The RF transceivers in the remote antenna units are transparent to the RF signals. The remote antenna units convert incoming optical RF signals from the optical fiber link to electrical RF signals via optical-to-electrical (0/E) converters, which are then passed to the RF transceiver. The transceiver converts the electrical RF signals to electromagnetic signals via antennas coupled to the RF transceiver provided in the remote antenna units. The antennas also receive electromagnetic signals (i.e., electromagnetic radiation) from clients in the antenna coverage area and convert them to electrical RF signals (i.e., electrical RF signals in wire). The remote antenna units then convert the electrical RF signals via electrical-to-optical (E/O) converters. The optical RF signals are then sent to the head-end station via the optical fiber link.

It may be desired to provide such optical fiber-based distributed communications systems (or other distributed communication systems (e.g., coaxial and/or wirebased) indoors, such as inside a building or other facility, to provide indoor wireless communication for clients. Otherwise, wireless reception may be poor or not possible for wireless communication clients located inside the building. In this regard, the remote antenna units can be distributed throughout locations inside a building to extend wireless communication coverage throughout the building. Other services may be negatively affected or not possible due to the indoor environment. For example, it may be desired or required to provide localization services for a client, such as emergency 911 (E911) services as an example. If the client is located indoors, techniques such as global positioning services (GPS) may not be effective at providing or determining the location of the client. Further, triangulation techniques from the outside network may not be able to determine the location of the client.

### SUMMARY OF THE DETAILED DESCRIPTION

Embodiments disclosed herein include a location tracking for mobile terminals. Related components, systems, and methods are also disclosed herein. For example, the systems disclosed herein can provide location information to mobile terminals that may not be able to receive otherwise global positioning system (GPS) information from the GPS satellites, such as, for example, when the mobile terminal does not receive GPS signals from the GSP satellites. Providing location information to clients inside a building or other location may make location based services, such as emergency (E911) services, for example, possible based on the location information.

In this regard, in one embodiment, a distributed communications apparatus comprises for example, at least a first downlink input configured to receive downlink communications signals and, for example, at least a first interface configured to receive and provide the downlink communications signals to a remote unit. The remote unit is configured to provide location indicia within a service set identifier (SSID) signal to a wireless client within an antenna coverage area associated with the remote unit.

In another embodiment, a method comprises receiving downlink communications signals at a downlink input and providing the downlink communications signals to a remote unit. The method further comprises providing from the remote unit location indicia within an SSID signal to a wireless client within an antenna coverage area associated with the remote unit.

In another embodiment, a wireless client comprises a user interface and a transceiver configured to send and receive wireless uplink and wireless downlink signals to a remote unit. The wireless client further comprises a control system operably connected to the user interface and the transceiver, the control system configured to receive location indicia within an SSID signal from the remote unit.

As non-limiting examples, the network may be an indoor distributed antenna system or a wireless local area network. The location indicia sent to the wireless client may be three dimensional coordinates including floor level of the building or an address for a server that tells the wireless client the location of remote units from which the wireless client may calculate location.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1A is a schematic diagram of an exemplary optical fiber-based distributed communications system;

FIG. 1B is a block diagram of an exemplary wireless client that may be used in a distributed communications system;

FIG. 2 is a partially schematic cut-away diagram of an exemplary building infrastructure in which an optical fiber-based distributed communications system is employed;

FIG. 3 is a partially schematic cut-away diagram of an exemplary building infrastructure wherein the optical fiber-based distributed communications system employs access points;

FIG. 4 is a partially schematic cut-away diagram of an exemplary building infrastructure with a wireless local area network communications system;

FIG. 5 is a partially schematic cut-away diagram of an exemplary building infrastructure with a wireless local area network communications system having additional beacon terminals;

FIG. 6 is a flow chart of an exemplary communication sequence through which a wireless client may ascertain its location;

FIG. 7 is a flow chart of an alternate exemplary communication sequence through which a wireless client may ascertain its location;

FIG. 8 is a schematic diagram of a generalized representation of an exemplary computer system that can be included in any of the modules provided in the exemplary distributed antenna systems and/or their components described herein, including but not limited to a head end controller (HEC), wherein the exemplary computer system is adapted to execute instructions from an exemplary computer-readable media.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein include a location tracking for mobile terminals. Related components, systems, and methods are also disclosed herein. For example, the systems disclosed herein can provide location information to mobile terminals that may not be able to receive otherwise global positioning system (GPS) information from the GPS satellites, such as, for example, when the mobile terminal does not receive GPS signals from the GSP satellites. Providing location information may make location based services, such as emergency (E911) services, for example, possible based on the location information.

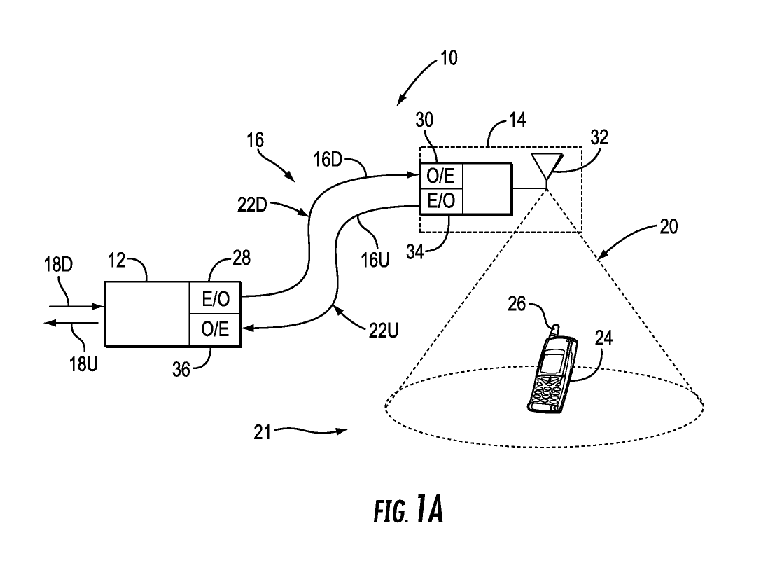

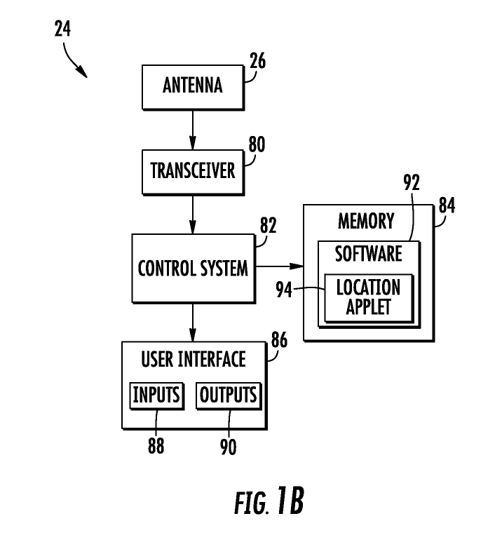

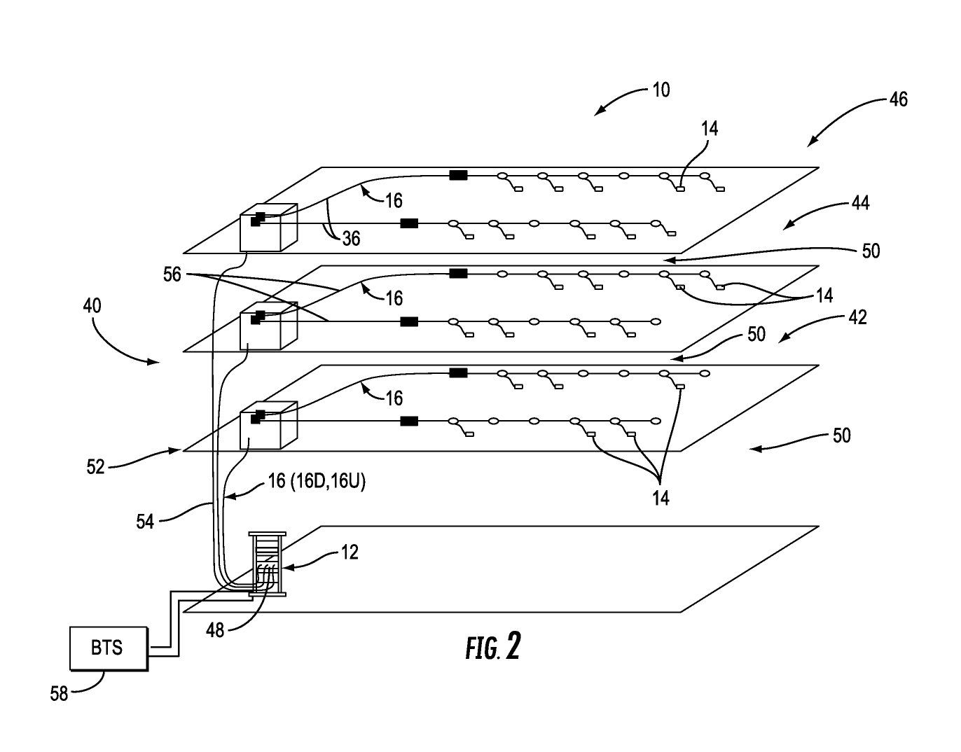

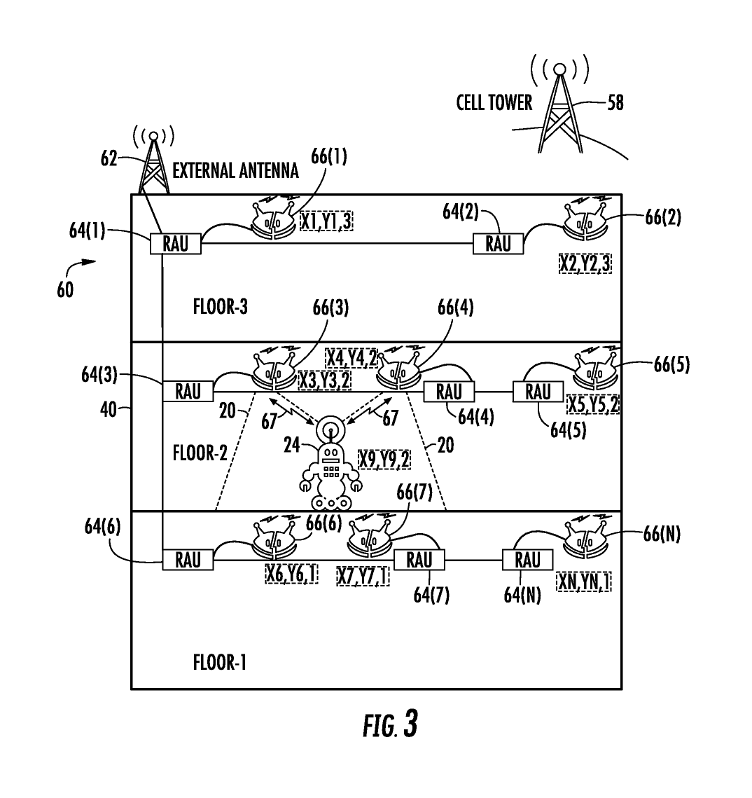

Before discussing the exemplary components, systems, and methods of providing localization services in a distributed communications system, which starts at FIG. 3, an exemplary generalized optical fiber-based distributed communications is first described with regard to FIGS. 1A, 1B, and 2. In this regard, FIG. 1A is a schematic diagram of a generalized embodiment of an optical fiber-based distributed communications system. In this embodiment, the system is an optical fiber-based distributed communications system 10 that is configured to create one or more antenna coverage areas for establishing communications with wireless client devices (sometimes referred to herein as mobile terminals) located in the radio frequency (RF) range of the antenna coverage areas. In this regard, the optical fiber-based distributed communications system 10 includes head-end equipment, exemplified as a head-end unit or HEU 12, one or more remote antenna units (RAUs) 14 and an optical fiber link 16 that optically couples the HEU to the RAU 14. The HEU 12 is configured to receive communications over downlink electrical RF signals 18D from a source or sources, such as a network or carrier as examples, and provide such communications to the RAU 14. The HEU 12 is also configured to return communications received from the RAU 14, via uplink electrical RF signals 18U, back to the source or sources. In this regard, in this embodiment, the optical fiber link 16 includes at least one downlink optical fiber 16D to carry signals communicated from the HEU 12 to the RAU 14 and at least one uplink optical fiber 16U to carry signals communicated from the RAU 14 back to the HEU 12. Note that there are embodiments where both the uplink and downlink signals 18U, 18D are transmitted on the same optical fiber 16, albeit at different frequencies. The present disclosure is operable in both situations.

The optical fiber-based wireless system 10 has an antenna coverage area 20 that can be substantially centered about the RAU 14. The antenna coverage area 20 of the RAU 14 forms an RF coverage area 21. The HEU 12 is adapted to perform or to facilitate any one of a number of Radio-over Fiber (RoF) applications, such as radio-frequency identification (RFID), wireless local-area network (WLAN) communication, or cellular phone service. Shown within the antenna coverage area 20 is a client device 24 in the form of a mobile terminal as an example, which may be a cellular telephone, smartphone, tablet computer, or the like as an example. The client device 24 can be any device that is capable of receiving RF communication signals. The client device 24 includes an antenna 26 (e.g., a wireless card) adapted to receive and/or send electromagnetic RF signals.

With continuing reference to FIG. 1A, to communicate the electrical RF signals over the downlink optical fiber 16D to the RAU 14, to in turn be communicated to the client device 24 in the antenna coverage area 20 formed by the RAU 14, the HEU 12 includes an electrical-to-optical (E/O) converter 28. The E/O converter 28 converts the downlink electrical RF signals 18D to downlink optical RF signals 22D to be communicated over the downlink optical fiber 16D. The RAU 14 includes an optical-to-electrical (O/E) converter 30 to convert received downlink optical RF signals 22D back to electrical signals to be communicated wirelessly through an antenna 32 of the RAU 14 to client devices 24 located in the antenna coverage area 20.

Similarly, the antenna 32 is also configured to receive wireless RF communications from client devices 24 in the antenna coverage area 20. In this regard, the antenna 32 receives wireless RF communications from client devices 24 and communicates electrical RF signals representing the wireless RF communications to an E/O converter 34 in the RAU 14. The E/O converter 34 converts the electrical RF signals into uplink optical RF signals 22U to be communicated over the uplink optical fiber 16U. An 0/E converter 36 provided in the HEU 12 converts the uplink optical RF signals 22U into uplink electrical RF signals, which can then be communicated as uplink electrical RF signals 18U back to a network or other source. The client device 24 could be in range of any antenna coverage area 20 formed by a RAU 14.

With reference to FIG. 1B, a block diagram of a wireless client is provided. The wireless client device 24 (sometimes referred to as wireless clients) includes the antenna 26 and a wireless transceiver 80, a control system 82, computer readable memory 84, and a user interface 86. The user interface 86 includes inputs 88 and outputs 90 such as a keypad, touch screen, or the like. The computer readable memory 84 includes software 92 including a location applet 94 which may perform some of the operations of the present disclosure. In an alternate embodiment, the location applet may be stored elsewhere in the wireless client 24. For example, the location applet may be in the transceiver 80, or within an element such as a digital signal processor (not shown) within the transceiver 80. Wireless clients 24 may be cellular phones, smart phones, tablet computers or the like.

While not explicitly set forth in FIG. 1B, the client device 24 may further include one or more of an accelerometer, compass, gyroscope, and/or other internal sensors. These internal sensors may be accessed by a user through the user interface 86 in conjunction with an application stored in memory 84. Alternatively, such internal sensors may be accessed without user intervention by another application such as location applet 94.

To provide further exemplary illustration of how an optical fiber-based distributed communications system can be deployed indoors, FIG. 2 is a partially schematic cut-away diagram of a building infrastructure 40 employing the optical fiber-based distributed communications system 10 of FIG. 1A. The building infrastructure 40 generally represents any type of building in which the optical fiber-based distributed communications system 10 can be deployed. As previously discussed with regard to FIG. 1, the optical fiber-based distributed communications system 10 incorporates the HEU 12 to provide various types of communication services to coverage areas within the building infrastructure 40, as an example. For example, as discussed in more detail below, the optical fiber-based distributed communications system 10 in this embodiment is configured to receive wireless RF signals and convert the RF signals into Radio-over-Fiber (RoF) signals to be communicated over the optical fiber link 16 to the RAUs 14. The optical fiber-based distributed communications system 10 in this embodiment can be, for example, an indoor distributed antenna system (IDAS) to provide wireless service inside the building infrastructure 40. The wireless signals can include, but are not limited to, cellular service, wireless services such as RFID tracking, Wireless Fidelity (WiFi), local area network (LAN), and combinations thereof, as examples.

With continuing reference to FIG. 2, the building infrastructure 40 includes a first (ground) floor 42, a second floor 44, and a third floor 46. The floors 42, 44, 46 are serviced by the HEU 12 through a main distribution frame 48, to provide antenna coverage areas 50 in the building infrastructure 40. Only the ceilings of the floors 42, 44, 46 are shown in FIG. 2 for simplicity of illustration. In the example embodiment, a main cable 52 has a number of different sections that facilitate the placement of a large number of RAUs 14 in the building infrastructure 40. Each RAU 14 in turn services its own coverage area in the antenna coverage areas 50. The main cable 52 can include, for example, a riser section 54 that carries all of the downlink and uplink optical fibers 16D, 16U to and from the HEU 12. The main cable 52 can include one or more multi-cable (MC) connectors adapted to connect select downlink and uplink optical fibers 16D, 16U, along with an electrical power line, to a number of optical fiber cables 56.

The main cable 52 enables multiple optical fiber cables 56 to be distributed throughout the building infrastructure 40 (e.g., fixed to the ceilings or other support surfaces of each floor 42, 44, 46) to provide the antenna coverage areas 50 for the first, second, and third floors 42, 44, and 46. In an example embodiment, the HEU 12 is located within the building infrastructure 40 (e.g., in a closet or control room), while in another embodiment the HEU 12 may be located outside of the building infrastructure 40 at a remote location. A base transceiver station (BTS) 58, which may be provided by a second party such as a cellular service provider, is connected to the HEU 12, and can be co-located or located remotely from the HEU 12. A BTS is any station or source that provides an input signal to the HEU 12 and can receive a return signal from the HEU 12. In a typical cellular system, for example, a plurality of BTSs is deployed at a plurality of remote locations to provide wireless telephone coverage. Each BTS serves a corresponding cell and when a mobile terminal enters the cell, the BTS communicates with the mobile terminal. Each BTS can include at least one radio transceiver for enabling communication with one or more subscriber units operating within the associated cell.

FIGS. 1A and 2 are directed to optical fiber implementations, but the present disclosure is not so limited. Rather, any distributed antenna system, wire-based or a hybrid of wire and optical fiber cables or the like, may be used with exemplary embodiments of the present disclosure. Likewise, while FIGS. 1A and 2 focus on the provision of cellular services and/or the provision of WLAN services “riding” on the fiber network, the present disclosure also is operable with a network that is designed as a WLAN and has a wire-based solution (e.g., twisted pair, CAT5, CAT6, coaxial, pure optical, hybrid (optical and coax), or the like). The present disclosure is likewise operable with composite cabling structures (e.g., where there are DC power wires and fiber strands in a single cable).

The need for interior distributed antenna systems arises from the fact that many wireless signals are unable to penetrate the walls and interior barriers of a building. In instances where the wireless signals do penetrate the walls and interior barriers of a building, the signals may be so attenuated that the wireless clients are unable to process those signals effectively. DAS and WLAN systems (and combinations of these systems) are effective at providing cellular and WiFi signals to wireless clients, but to date have not proven effective at providing location information. Such location information may be needed to provide E911 services and/or other location based services.

It may be desirable to leverage the distributed communications systems so as to provide location indicia to the mobile terminals so that a mobile terminal may ascertain its location such that the location may be reported to an E911 service or other location based services may be requested/provided. The present disclosure incorporates location information into a service set identifier (SSID) signal within WLAN access points and beacon terminals that are associated with the wireless communications systems.

In this regard, FIG. 3 illustrates an IDAS 60. The IDAS 60 includes an external antenna 62 that communicates with the BTS 58 via wireless signals as explained above. The IDAS 60 further includes RAUs 64(1)-64(N) distributed throughout the building infrastructure 40. One or more of the RAUs 64(1)-64(N) are coupled to WLAN access points 66(1)-66(N) as is understood by someone of ordinary skill in the art. The access points communicate wirelessly with the client devices 24 within the antenna coverage areas 20. Each access point 66(1)-66(N) transmits a service set identifier (SSID) signal that includes the location of the access point 66. In an exemplary embodiment, each access point 66 transmits an SSID signal 67 that has the three dimensional coordinates of the access point 66 (e.g., x, y, and z). In a further exemplary embodiment, the z coordinate may be a floor level (e.g., 1st, 2nd, 3rd . . . ). The wireless client 24 may receive a plurality of SSID signals from various ones of the access points 66(1)-66(N), although it should be noted that in many building infrastructures 40, the concrete in the floor causes inter-floor signals to be greatly attenuated. The wireless client 24 may determine a received signal strength indication (RSSI) for each received SSID signal, and coupled with the coordinates embedded in the SSID signal, the wireless client 24 may calculate through any appropriate algorithm (e.g., trilateration or triangulation) the location of the wireless client 24. The wireless client 24 may include an applet or other software or hardware to effectuate the calculation of the location. Once calculated, the location may then be provided to other programs that can use that location (e.g., provision of E911 services or other location based services). In an exemplary embodiment, trilateration or triangulation may provide location accuracy of approximately five (5) meters to thirty (30) meters depending on the density of access points 66. The internal sensors of the wireless client 24 (e.g., the accelerometer, compass, and the like) may be used to improve the accuracy of the location calculated. That is, the location applet 94 may interrogate such sensors and use the information so provided to provide additional data points in a location determination algorithm.

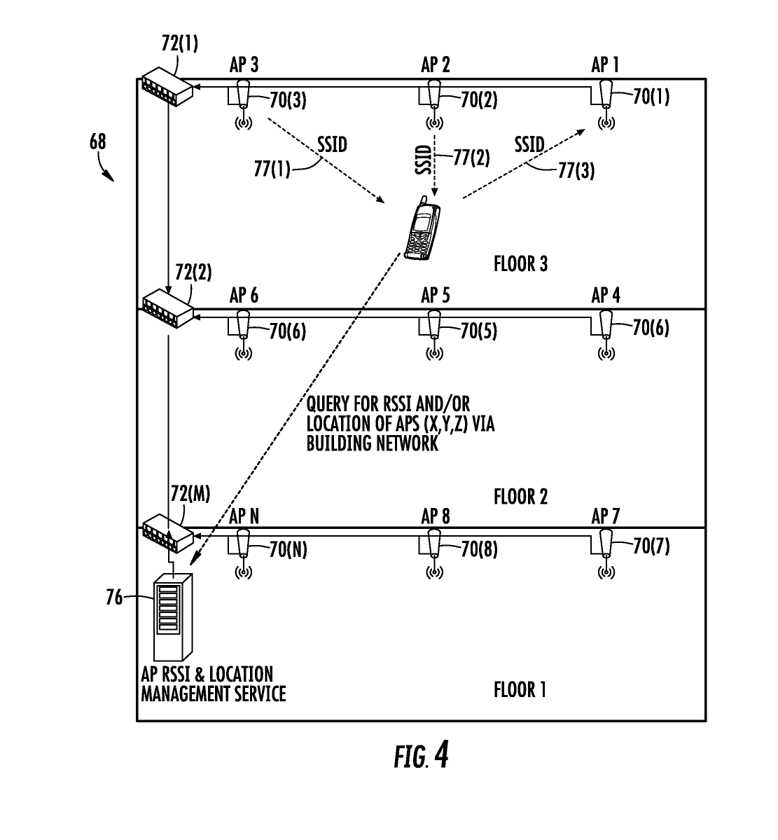

While the IDAS 60 of FIG. 3 provides high bandwidth capabilities to provide a number of services concurrently, the present disclosure is not so limited. For example, as illustrated in FIG. 4, a WLAN system 68 may provide WiFi services to wireless clients 24 without needing an DAS infrastructure. Thus, the WLAN system 68 may comprise one or more access points (AP) 70(1)-70(N) coupled to hubs 72(1)-72(M) by cabling 74. Cabling 74 may, for example, be CAT5, CAT6 or other cabling as desired.

With continuing reference to FIG. 4, the WLAN system 68 may further include a location services server 76. In the exemplary embodiment of FIG. 4, the APs 70(1)-70(N) may transmit respective SSID signals 77(1)-77(N). As discussed above with respect to FIG. 3, the SSID signals may include location information and, in an exemplary embodiment, may include three dimensional coordinates including a floor level. As illustrated, the wireless client 24 may receive multiple SSID signals 77 (as illustrated, the wireless client 24 receives SSID signals 77(1)-77(3)). As noted above, the concrete in the floors may practically preclude reception of an SSID signal 77 by the wireless client 24 from a floor other than the floor on which the wireless client is located (as illustrated, the wireless client will not receive the SSID signal 77(4) from the AP 70(4)). As described above with reference to FIG. 3, the wireless client 24 may receive multiple SSID signals 77 and ascertain an RSSI for the received SSID signals 77 and from these values calculate a location for the wireless client 24.

Instead of receiving the coordinates from the APs 66 or 70, the wireless client 24 may receive other location information which allows the wireless client to ascertain its location. For example, the SSID signals 67, 77 may provide a network address (or other unique identifier) of a location services server such as location services server 76. The SSID signals 67, 77 may further include a network address for the respective AP 66(1)-66(N) or 70(1)-70(N) which transmitted the SSID signal 67, 77. The wireless client 24 may then communicate with the location services server 76 (either through the WLAN system 68 or perhaps on a cellular frequency or SNMP) and query the location services server 76 as to the coordinates of the AP 66, 70 whose address was extracted from the SSID signal 67, 77. The location services server 76 may have the coordinates stored in a database or look up table and provide the coordinates of the AP 66, 70 on receiving the appropriate query from the wireless client 24. Equipped with the coordinates of the AP 66, 70 and the RSSI, the wireless client 24 may calculate its location. In another exemplary embodiment, the location services server 76 may perform the calculations and report the location to the wireless client 24.

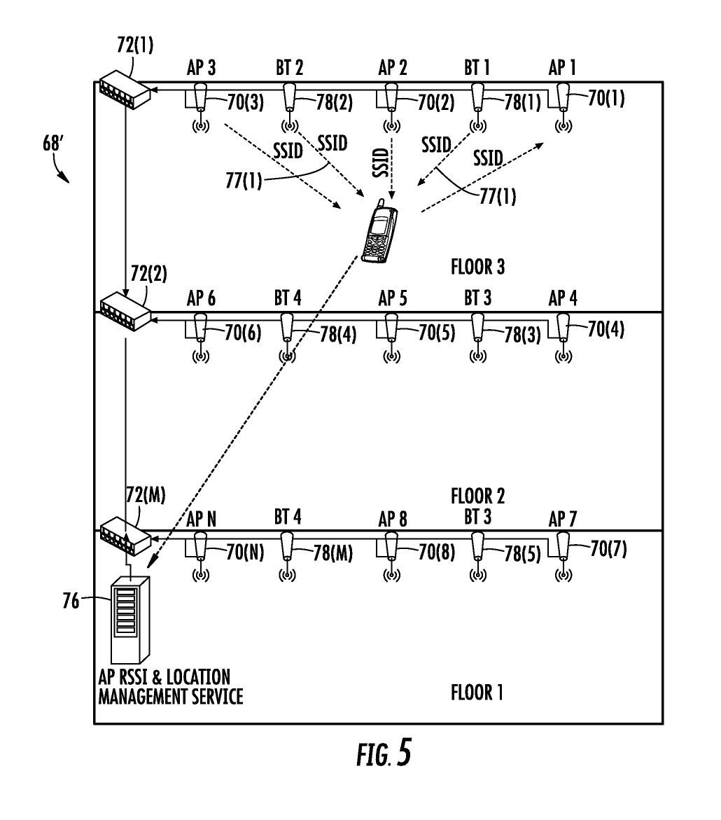

While the embodiments of FIGS. 3 and 4 are useful in helping provide location based services, the AP 66, 70 are relatively expensive. To ameliorate the cost, beacon terminals may be seeded into the distributed communications system. In an exemplary embodiment a beacon terminal may be relative “dumb” terminals and thus are relatively inexpensive and may be seeded throughout the distributed communications system heavily. The more heavily these beacon terminals are seeded, the greater potential for highly accurate location determination is achieved. An exemplary embodiment is provided with reference to FIG. 5. Here the WLAN system 68′ is substantially similar to WLAN system 68, but beacon terminals (BTs) 78(1)-78(M) are provided. The BTs 78(1)-78(M) likewise have an SSID signal 77′ which includes either the coordinates of the BT 78 or the network address of the location services server 76. While the WLAN system 68′ is illustrated, it should be appreciated that the beacon terminal may be used in an DAS as well without departing from the scope of the present disclosure. In an exemplary embodiment, the BTs 78(1)-78(M) do not allow association or data transmission beyond the transmission of the SSID signal 77′ (i.e., they are “dumb” terminals). Note that in some exemplary embodiments, the beacon terminals 78 may be associated with power cables such as a composite cable having both DC power wires and fiber strands in a single cable. In such an exemplary embodiment, the beacon terminals 78 may use the DC power wires for power and/or separate copper wires for communication. In an alternate embodiment, the beacon terminals 78 may use the DC power wires for both power and communication signals.

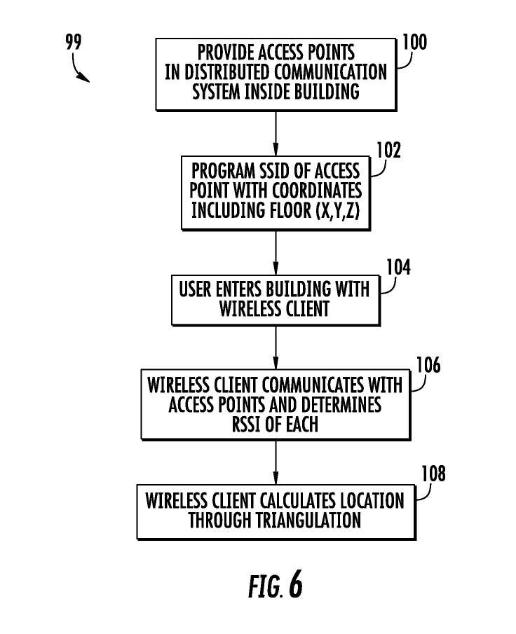

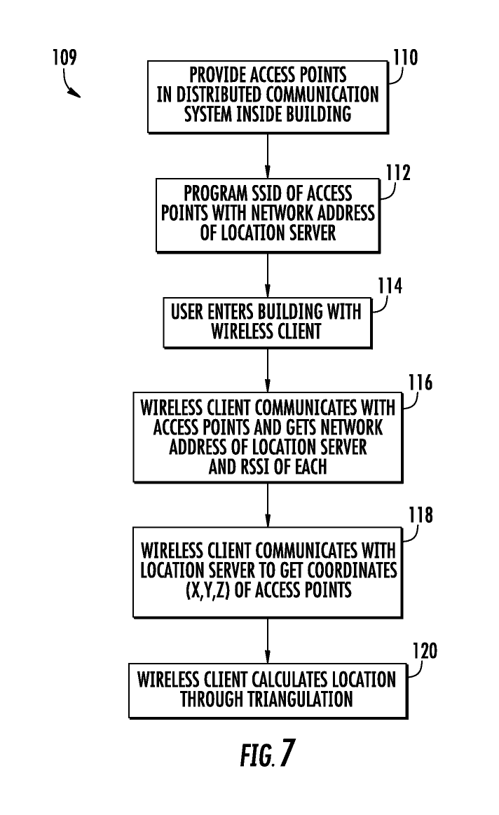

FIGS. 6 and 7 illustrate exemplary methodologies of the present disclosure in flow chart format. With reference to FIG. 6, an exemplary embodiment is provided. The initial step of method 99 is the system operator provides access points 66, 70 in a distributed communications system 60, 68, 68′ (block 100). Each AP 66, 70 is programmed so that it broadcasts or otherwise transmits a SSID with coordinates (X, Y, Z) including a floor coordinate (block 102). A user enters a building infrastructure 40 with a wireless client 24 (block 104). The wireless client 24 communicates with the access points 66, 70, receives the coordinates and determines the RSSI of the access points 66, 70 within range (block 106). The wireless client 24 then calculates its location through triangulation, trilateration or comparable technique (with or without an algorithm being used (e.g., a look up table) (block 108). As noted above, the control system 82 may cause the location applet 94 to perform the calculations.

In an alternate method 109, illustrated in FIG. 7, the system operator provides access points 66, 70 in a distributed communications system 60, 68, 68′ (block 110). Each AP 66, 70 is programmed so that it broadcasts or otherwise transmits a SSID with a network address (or other unique identifier) of the location services server 76 (block 112). Note that while it is contemplated that the AP 66, 70 is programmed, other techniques may be used to ascertain the location of the AP 66, 70. A user enters a building infrastructure with a wireless client 24 (block 114). The wireless client 24 communicates with one or more access points 66, 70 and receives the network address of the location services server 76 and calculates the RSSI of each AP 66, 70 (block 116). The wireless client 24 communicates with the location services server 76 and gets the coordinates (X, Y, Z) of the access points 66, 70 with which the wireless client 24 is in communication (block 118). In an alternate embodiment, instead of the location coordinates of the AP 66, 70, other information sufficient to ascertain the location of the wireless client 24 is provided. The wireless client 24 calculates the location of the wireless client 24 through triangulation, trilateration, or other technique (block 120).

The location services server 76 may also, in an exemplary embodiment, alert the installer of a potential location change if power at an RAU 14 or BT 78 is cycled. The location services server 76 may also, in an exemplary embodiment, provide a map to the wireless client 24 in addition to the coordinates of the RAU 14, BT 78. The location services server 76 may also, in an exemplary embodiment, provide routing information on a map to guide a user from one point to another point. For example, the wireless client 24 may receive a map and instructions on how to get from the food court of a mall to a particular store. The location services server 76 may also, in an exemplary embodiment, receive an initial starting position from the wireless client 24 to assist in the creation of such map and instructions.

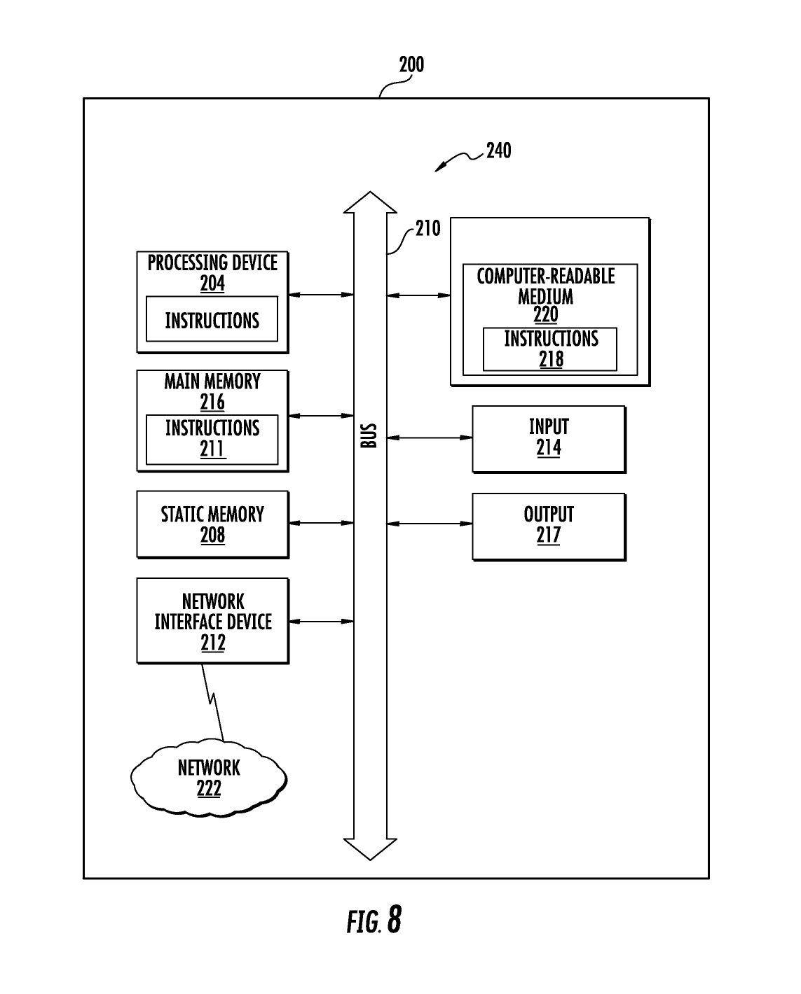

The distributed communications systems 60, 68, 68′ disclosed herein can include a computer system (e.g., HEU 12, RAU 14, location services server 76). In this regard, FIG. 8 is a schematic diagram representation of additional detail regarding such computer systems in the exemplary form of an exemplary computer system 200 adapted to execute instructions from an exemplary computer-readable medium to perform power management functions. In this regard, the computer system 200 may include a set of instructions for causing the computer system 200 to perform any one or more of the methodologies discussed herein may be executed. The computer system 200 may be connected (e.g., networked) to other machines in a LAN, an intranet, an extranet, or the Internet. The computer system 200 may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The computer system 200 may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer.

The exemplary computer system 200 in this embodiment includes a processing device or processor 204, a main memory 216 (e.g., read-only memory (ROM), flash memory, dynamic random access memory (DRAM) such as synchronous DRAM (SDRAM), etc.), and a static memory 208 (e.g., flash memory, static random access memory (SRAM), etc.), which may communicate with each other via the data bus 210. Alternatively, the processing device 204 may be connected to the main memory 216 and/or static memory 208 directly or via some other connectivity means. The processing device 204 may be a controller, and the main memory 216 or static memory 208 may be any type of memory.

The processing device 204 represents one or more general-purpose processing devices such as a microprocessor, central processing unit, or the like. More particularly, the processing device 204 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 204 is configured to execute processing logic in instructions for performing the operations and steps discussed herein.

The computer system 200 may further include a network interface device 212. The computer system 200 also may or may not include an input 214 to receive input and selections to be communicated to the computer system 200 when executing instructions. The computer system 200 also may or may not include an output 217, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 200 may or may not include a data storage device that includes instructions 218 stored in a computer-readable medium 220. The instructions 218 may also reside, completely or at least partially, within the main memory 216 and/or within the processing device 204 during execution thereof by the computer system 200, the main memory 216 and the processing device 204 also constituting computer-readable medium. The instructions 211 may further be transmitted or received over a network 222 via the network interface device 212.

While the computer-readable medium 220 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing device and that cause the processing device to perform any one or more of the methodologies of the embodiments disclosed herein.

The embodiments disclosed herein include various steps. The steps of the embodiments disclosed herein may be performed by hardware components, software components, and combinations thereof.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein.

Unless specifically stated otherwise as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. In addition, the embodiments described herein are not described with reference to any particular programming language.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like.

the antenna arrangements may include any type of antenna desired, including but not limited to dipole, monopole, and slot antennas. The distributed antenna systems that employ the antenna arrangements disclosed herein could include any type or number of communications mediums, including but not limited to electrical conductors, optical fiber, and air (i.e., wireless transmission). The distributed antenna systems may distribute and the antenna arrangements disclosed herein may be configured to transmit and receive any type of communications signals, including but not limited to RF communications signals and digital data communications signals, examples of which are described in U.S. patent application Ser. No. 12/892,424 entitled “Providing Digital Data Services in Optical Fiber-based Distributed Radio Frequency (RF) Communications Systems, And Related Components and Methods,” incorporated herein by reference in its entirety. Multiplexing, such as WDM and/or FDM, may be employed in any of the distributed antenna systems described herein, such as according to the examples provided in U.S. patent application Ser. No. 12/892,424.

Therefore, it is to be understood that the description and claims are not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A distributed communications apparatus, comprising:
at least one downlink input configured to receive downlink communications signals; and
at least one interface configured to receive and provide the downlink communications signals to a remote unit, wherein
the remote unit is configured to provide location indicia within an SSID signal to a wireless client within an antenna coverage area associated with the remote unit.

2. The distributed communications apparatus of claim 1, further comprising at least one uplink output configured to receive and communicate uplink communications signals from a communications uplink.

3. The distributed communications apparatus of claim 1, wherein the remote unit configured to provide location indicia within the SSID signal is configured to provide three dimensional coordinate information.

4. The distributed communications apparatus of claim 3, wherein the remote unit configured to provide three dimensional coordinate information is configured to provide floor information.

5. The distributed communications apparatus of claim 1, wherein the remote unit comprises an access point.

6. The distributed communications apparatus of claim 1, wherein the remote unit comprises a remote antenna unit coupled with an access point.

7. The distributed communications apparatus of claim 1, wherein the remote unit comprises a beacon terminal.

8. The distributed communications apparatus of claim 5, wherein the beacon terminal is configured to couple to a cable and to receive power over wires within the cable.

9. The distributed communications apparatus of claim 8, wherein the cable comprises a composite electrically conductive and optical cable.

10. The distributed communications apparatus of claim 1, wherein the remote unit configured to provide location information within the SSID signal is configured to provide a network address of a server configured to provide coordinate information relating to the remote unit to the wireless client.

11. The distributed communications apparatus of claim 1, wherein the distributed communications apparatus comprises an optical fiber based distributed antenna system.

12. The distributed communications apparatus of claim 1, wherein the distributed communications apparatus comprises a WLAN system.

13. A method to assist in provision of location based services, comprising:
receiving downlink communications signals at at least one downlink input;
providing the downlink communications signals to a remote unit; and
providing from the remote unit location indicia within an SSID signal to a wireless client within an antenna coverage area associated with the remote unit.

14. The method of claim 13, further comprising receiving uplink communications signals from the wireless client.

15. The method of claim 13, wherein providing from the remote unit location indicia comprises providing three dimensional coordinate information including floor information.

16. The method of claim 13, wherein providing from the remote unit comprises providing from a beacon terminal.

17. The method of claim 13, wherein providing from the remote unit comprises providing from a remote antenna unit coupled with an access point.

18. The method of claim 13, wherein providing location indicia comprises providing a network address of a server configured to provide coordinate information relating to the remote unit to the wireless client.

19. The method of claim 18, further comprising, providing, from the server, location information relating to the remote unit by calculating a location for the wireless client.

20. The method of claim 13, wherein providing the downlink communications signals to the remote unit comprises using at least one of an optical fiber based distributed antenna system and a WLAN system.

21. The method of claim 13, wherein providing location indicia comprises providing a map to the wireless client, the method further comprising providing routing information related to the map.

22. A wireless client, comprising:
a user interface;
a transceiver configured to send and receive wireless uplink and wireless downlink signals to a remote unit; and
a control system operably connected to the user interface and the transceiver, the control system configured to receive location indicia within an SSID signal from the remote unit.

23. The wireless client of claim 22, wherein the control system configured to receive location indicia within the SSID signal receives three dimensional coordinates.

24. The wireless client of claim 22, wherein the control system configured to receive location indicia within the SSID signal receives floor information.

25. The wireless client of claim 22, wherein the control system configured to receive location indicia receives an address of a server and the control system is further configured to receive location information associated with the remote unit from the server.

26. The wireless client of claim 22, further comprising a sensor and wherein the control system is further configured to use data from the sensor in conjunction with the location indicia in calculating a current position of the wireless client.
